(19) United States
(12) Patent Application Publication
(10) Pub. No.: US 2012/0006258 A1
(43) Pub. Date: Jan. 12, 2012

(54) HYDROGEN RADICAL GENERATOR

(75) Inventors: Gerard Frans Jozef Schasfoort, Eindhoven (NL); Jeroen Marcel Huijbregtse, Breda (NL); Roeland Nicolaas Maria Vanneer, Eindhoven (NL); Arnoldus Jan Storm, Delft (NL); Edwin Te Sligte, Eindhoven (NL); Antonius Theodorus Wilhelmus Kempen, 's-Hertogenbosch (NL); Wouter Andries Jonker, Dordrecht (NL); Timo Huijser, Zoetermeer (NL)

(73) Assignee: ASML Netherlands B.V., Veldhoven (NL)

(21) Appl. No.: 13/156,960

(22) Filed: Jun. 9, 2011

Related U.S. Application Data
(60) Provisional application No. 61/353,359, filed on Jun. 10, 2010.

(51) Int. Cl. B05C 11/00; B08B 7/00

(52) U.S. Cl. 118/63; 134/2; 134/105

(57) ABSTRACT

A method of reducing contamination generated by a hydrogen radical generator and deposited on an optical element of a lithographic apparatus includes passing molecular hydrogen over a first part of a metal filament of the hydrogen radical generator, the first part including a metal-oxide, when the temperature of the first part of the metal filament is at a reduction temperature less than or equal to an evaporation temperature of the metal-oxide.

### CROSS-REFERENCE TO RELATED APPLICATIONS

This application claims the benefit of priority from U.S. Provisional Patent Application No. 61/353,359, filed Jun. 10, 2010, the entire content of which is incorporated herein by reference.

### FIELD

The invention relates to a hydrogen radical generator, and/or a method of using a hydrogen radical generator, in relation to an optical element of a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing (i.e. pattern application) can be given by the Rayleigh criterion for resolution as shown in equation (1):

$$CD = {k}_{1} * \frac{λ}{NA} \qquad ( 1 )$$

where λ is the wavelength of the radiation used, NA is the numerical aperture of the projection system used to print (i.e. apply) the pattern, k₁ is a process dependent adjustment factor, also called the Rayleigh constant, and CD is the feature size (or critical dimension) of the printed (i.e. applied) feature. It follows from equation (1) that reduction of the minimum printable (i.e. applicable) size of features can be obtained in three ways: by shortening the exposure wavelength λ, by increasing the numerical aperture NA or by decreasing the value of k₁.

In order to shorten the exposure wavelength and, thus, reduce the minimum printable (i.e. applicable) feature size, it has been proposed to use an extreme ultraviolet (EUV) radiation source. EUV radiation is electromagnetic radiation having a wavelength within the range of 5-20 nm, for example within the range of 13-14 nm, or example within the range of 5-10 nm such as 6.7 nm or 6.8 nm. Possible sources include, for example, laser-produced plasma (LPP) sources, discharge plasma (DPP) sources, or sources based on synchrotron radiation provided by an electron storage ring.

EUV radiation may be produced using a plasma. A radiation system for producing EUV radiation may include a laser for exciting a fuel to provide the plasma, and a source collector module for containing the plasma. The plasma may be created; for example, by directing a laser beam at a fuel, such as particles of a suitable material (e.g. tin), or a stream of a suitable gas or vapor, such as Xe gas or Li vapor. The resulting plasma emits output radiation, e.g., EUV radiation, which is collected using a radiation collector. The radiation collector may be a mirrored normal incidence radiation collector, which receives the radiation and focuses the radiation into a beam. The source collector module may include an enclosing structure or chamber arranged to provide a vacuum environment to support the plasma. Such a radiation system is typically termed a laser produced plasma (LPP) source.

In a lithographic apparatus, optical elements (e.g. mirrors, or lenses, or sensors) will be used to direct, condition, pattern, and generally manipulate a radiation beam, or to detect something. In such a lithographic apparatus, and in particular an EUV apparatus, the optical elements may become contaminated. Contamination may result from contamination passing from a source onto the optical elements. Irradiation of the optical elements by the radiation beam may influence the contamination. For example, contamination in the form of a region or a layer of carbon may form on the optical elements (for example, a surface of the optical element on which radiation is incident). Contamination can lead to a degradation in the optical performance of the optical elements, and thus the optical performance of the lithographic apparatus as a whole. It is therefore desirable to reduce contamination of the optical elements.

A reduction in contamination of the optical elements can be achieved using one or both of two approaches. A first approach relies on the prevention of the contamination reaching the optical elements from, for example, a source of contamination, such as an EUV radiation source. A second approach relies on the removal of contamination from the optical element—i.e. cleansing the optical element of the contamination. Contamination can be prevented from reaching the optical element by using one or more contamination traps or the like, known in the art. Contamination can be removed from an optical element using a cleansing method. Such a cleansing method might involve the use of hydrogen radicals. Hydrogen radicals may react with contamination in the form of carbon on the optical element. When the hydrogen radicals react with the carbon, volatile hydrocarbons may be formed, which can be extracted from the lithographic apparatus (e.g. by appropriate pumping).

A hydrogen radical generator used to generate hydrogen radicals may comprise of a metal filament (which may be a pure metal, or an alloy), over which molecular hydrogen may be passed in use. The metal filament is heated to a sufficient temperature to atomize molecular hydrogen (e.g. in gas form) and to generate atomic hydrogen and thus hydrogen radicals. At the temperatures that are required to atomize the molecular hydrogen, any metal-oxides present on the metal filaments are likely to evaporate. The evaporated metal-oxides may contaminate the optical elements which the hydrogen radicals are used to clean.

The metal filament may be exposed to an oxidant (e.g. air, oxygen, water or the like) when the lithographic apparatus or the hydrogen radical generator is manufactured, transported, opened up for maintenance, or the like. Thus, it is likely that during the lifetime of the hydrogen radical generator, a metal filament will be exposed to an oxide on many occasions. As a result of subsequent use of the hydrogen radical generator, there might be a build up of contamination, particularly metal-based contamination, such as a metal oxide, on the optical elements of the lithographic apparatus. The hydrogen radicals generated by the hydrogen radical generator might react with the metal oxide on the optical surfaces to (partly) produce the pure metal, but this will not be in the gaseous phase and thus may not be pumped away effectively. Therefore, the hydrogen radicals may not effectively remove the metal based contamination from the optical surfaces. Therefore, using existing apparatus and methods, metal-based contamination may build up on the optical elements of the lithographic apparatus, resulting in a degradation of the optical performance of those optical elements, and thus the lithographic apparatus as a whole.

### SUMMARY

It is desirable to provide an apparatus and/or method which obviates or mitigates at least one challenge of the prior art, whether identified herein or elsewhere, or which provides an alternative to an existing apparatus and/or method.

According to an aspect of the invention, there is provided a method of reducing contamination generated by a hydrogen radical generator and deposited on an optical element of a lithographic apparatus (e.g. a mirror, a lens, a reflective element, a refractive element, or a sensor), the method comprising: providing molecular hydrogen to a first part of a metal filament of the hydrogen radical generator, the first part including a metal-oxide, when the first part of the metal filament is at a reduction temperature that is equal to or less than an evaporation temperature of the metal-oxide (which would, or would otherwise, form at least a portion of the contamination).

The method may be repeated to reduce an amount of oxide on a second, different part, for instance a cooler, part of the metal filament by increasing the overall filament temperature. A driving current of the metal filament may be increased for the repetition of the method.

The method may further comprise increasing the temperature of the metal filament to an atomization temperature, sufficient to atomize molecular hydrogen with which the metal filament is provided and to generate hydrogen radicals for use in cleansing the optical element.

The method may further comprise increasing the temperature of the metal filament to an atomization temperature, sufficient to atomize molecular hydrogen with passing over the metal filament and to generate hydrogen radicals for use in cleansing the optical element.

The method may be undertaken after the metal filament has been exposed to an oxidant, and before the temperature of the metal filament is increased to an atomization temperature, sufficient to atomize molecular hydrogen passing over the metal filament and to generate hydrogen radicals.

The atomization temperature may be substantially in the range of about 1300° C.-2500° C. The reduction temperature may be substantially in the range of about 400° C.-1200° C.

The metal may be a metal whose metal-oxides evaporate more readily than the metal in pure form.

The reduction temperature may be less than or equal to an atomization temperature which is sufficient to atomize molecular hydrogen passing over the metal filament and to generate hydrogen radicals.

The method may be undertaken when the hydrogen radical generator is in fluid connection with the lithographic apparatus.

This aspect of the invention may additionally comprise one or more features of other aspects of the invention.

According to an aspect of the invention, there is provided a hydrogen radical generator for use in cleansing an optical element of lithographic apparatus, comprising: a metal filament; and a controller configured to control a temperature of the metal filament, the controller being arranged to provide molecular hydrogen to the metal filament, the temperature of the first part of the metal filament is at a reduction temperature, less than or equal to an evaporation temperature of the metal-oxide.

This aspect of the invention may additionally comprise one or more features of other aspects of the invention.

According to an aspect of the invention, there is provided a method of reducing contamination generated by a hydrogen radical generator and deposited on an optical element of a lithographic apparatus, the method comprising evaporating part of metal-oxide present on a metal filament of the hydrogen radical generator. The part of metal-oxide present on a metal filament of the hydrogen radical generator may be evaporated when a barrier is provided constructed and arranged to prevent a hydrogen flow to be established to the filament and the optical element. Alternatively or in addition, the part of metal-oxide present on a metal filament of the hydrogen radical generator is evaporated when a barrier is located between the hydrogen radical generator and the optical element.

According to an aspect of the invention, there is provided a method of reducing contamination generated by a hydrogen radical generator and deposited on an optical element of a lithographic apparatus, the method comprising: evaporating metal-oxide present on a metal filament of the hydrogen radical generator (which would, or would otherwise, form at least a portion of the contamination) when a barrier is located between the hydrogen radical generator and the optical element.

The method may be undertaken after the metal filament has been exposed to the oxidant, and before cleansing of the optical element is undertaken using hydrogen radicals generated by the hydrogen radical generator.

Before, during, or after evaporation, molecular hydrogen may be passed over the metal filament when the temperature of the metal filament is lower than or equal to an atomization temperature, sufficient to atomize molecular hydrogen passing over the metal filament and to generate hydrogen radicals.

The barrier may be moveable from a first configuration, in which evaporated metal-oxide and/or hydrogen radicals is/are partly prevented from passing from the hydrogen radical generator to the optical element, to a second configuration, in which hydrogen radicals generated by the hydrogen radical generator are allowed to pass to the optical element.

The barrier may form part of a compartment surrounding the metal filament, or the hydrogen radical generator.

The barrier may form part of a compartment surrounding the optical element.

The barrier may be or comprise a shutter or the like.

The method may be undertaken when the hydrogen radical generator is in fluid connection with the lithographic apparatus.

Again, the metal may be a metal whose metal-oxides evaporate more readily than the metal in pure form.

This aspect of the invention may additionally comprise one or more features of other aspects of the invention.

According to an aspect of the invention, there is provided a lithographic apparatus comprising: an optical element; a hydrogen radical generator configured to generate hydrogen radicals for use in cleansing the optical element; and a barrier, arranged to be moveable between the hydrogen radical generator and the optical element when evaporation of metal-oxide on a metal filament of the hydrogen radical generator takes place.

This aspect of the invention may additionally comprise one or more features of other aspects of the invention.

The lithographic apparatus may further include an illumination system configured to condition a beam of radiation, a support configured to support a patterning device, the patterning device being configured to pattern the beam of radiation, and a projection system configured to project a patterned beam of radiation onto a substrate, wherein the optical element is part of the illumination system.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 is a more detailed view of the lithographic apparatus shown in FIG. 1, including a discharge produced plasma (DPP) source collector module SO;

FIG. 3 is a view of an alternative source collector module SO of the apparatus of FIG. 1, the alternative being a laser produced plasma (LPP) source collector module;

FIG. 4 schematically depicts a hydrogen radical generator in relation to an optical element of a lithographic apparatus;

FIG. 5 schematically depicts operation of the hydrogen radical generator of FIG. 4 in accordance with an embodiment of the invention;

FIG. 6 schematically depicts an effect of the operation shown in and described with reference to FIG. 5;

FIG. 7 schematically depicts a hydrogen radical generator in relation to an optical element of a lithographic apparatus, together with a barrier, in accordance with an embodiment of the invention; and

FIG. 8 schematically depicts the hydrogen radical generator and optical element and barrier of FIG. 7, but with the barrier being in a different configuration, in accordance with an embodiment of the invention; and

FIG. 9 schematically depicts a hydrogen radical generator in relation to an optical element of a lithographic apparatus, together with a barrier, in accordance with an embodiment of the invention.

### DETAILED DESCRIPTION

FIG. 1 schematically depicts a lithographic apparatus 100 including a source collector module SO according to one embodiment of the invention. The apparatus comprises: an illumination system (sometimes referred to as an illuminator) IL configured to condition a radiation beam B (e.g. EUV radiation); a support structure (e.g. a mask table) MT constructed to support a patterning device (e.g. a mask or a reticle) MA and connected to a first positioner PM configured to accurately position the patterning device MA; a substrate table (e.g. a wafer table) WT constructed to hold a substrate (e.g. a resist-coated wafer) W and connected to a second positioner PW configured to accurately position the substrate W; and a projection system (e.g. a reflective projection system) PS configured to project a pattern imparted to the radiation beam B by patterning device MA onto a target portion C (e.g. comprising one or more dies) of the substrate W.

The illumination system IL may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device MA, the design of the lithographic apparatus 100, and other conditions, such as for example whether or not the patterning device MA is held in a vacuum environment. The support structure MT can use mechanical, vacuum, electrostatic or other clamping techniques to hold the patterning device MA. The support structure MT may be a frame or a table, for example, which may be fixed or movable as required. The support structure MT may ensure that the patterning device MA is at a desired position, for example with respect to the projection system PS.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The projection system, like the illumination system, may include various types of optical components, such as refractive, reflective, magnetic, electromagnetic, electrostatic or other types of optical components, or any combination thereof, as appropriate for the exposure radiation being used, or for other factors such as the use of a vacuum. It may be desired to use a vacuum for EUV radiation since other gases may absorb too much radiation. A vacuum environment may therefore be provided to the whole beam path with the aid of a vacuum wall and vacuum pumps.

As here depicted, the apparatus is of a reflective type (e.g. employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illumination system IL receives an extreme ultra violet (EUV) radiation beam from the source collector module SO. Methods to produce EUV light include, but are not necessarily limited to, converting a material into a plasma state that has at least one element, e.g., xenon, lithium or tin, with one or more emission lines in the EUV range. In one such method, often termed laser produced plasma (LPP), the required plasma can be produced by irradiating a fuel, such as a droplet, stream or cluster of material having the required line-emitting element, with a laser beam. The source collector module SO may be part of an EUV radiation system including a laser, not shown in FIG. 1, for providing the laser beam exciting the fuel. The resulting plasma emits output radiation, e.g. EUV radiation, which is collected using a radiation collector, disposed in the source collector module. The laser and the source collector module may be separate entities, for example when a CO₂ laser is used to provide the laser beam for fuel excitation.

In such cases, the laser is not considered to form part of the lithographic apparatus and the radiation beam is passed from the laser to the source collector module with the aid of a beam delivery system comprising, for example, suitable directing mirrors and/or a beam expander. In other cases the source may be an integral part of the source collector module, for example when the source is a discharge produced plasma EUV generator, often termed as a DPP source.

The illumination system IL may comprise an adjuster for adjusting the angular intensity distribution of the radiation beam B. Generally, at least the outer and/or inner radial extent (commonly referred to as σ-outer and σ-inner, respectively) of the intensity distribution in a pupil plane of the illumination system IL can be adjusted. In addition, the illumination system IL may comprise various other components, such as facetted field and pupil mirror devices. The illumination system may be used to condition the radiation beam, to have a desired uniformity and intensity distribution in its cross-section.

The radiation beam B is incident on the patterning device (e.g. mask) MA, which is held on the support structure (e.g. mask table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor PS2 (e.g. an interferometric device, linear encoder or capacitive sensor), the substrate table WT can be moved accurately, e.g. so as to position different target portions C in the path of the radiation beam B. Similarly, the first positioner PM and another position sensor PS1 can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

The depicted apparatus could be used in at least one of the following modes:

1. In step mode, the support structure (e.g. mask table) MT and the substrate table WT are kept essentially stationary, while an entire pattern imparted to the radiation beam B is projected onto a target portion C at one time (i.e. a single static exposure). The substrate table WT is then shifted in the X and/or Y direction so that a different target portion C can be exposed.
2. In scan mode, the support structure (e.g. mask table) MT and the substrate table WT are scanned synchronously (e.g. in the X or Y direction) while a pattern imparted to the radiation beam is projected onto a target portion C (i.e. a single dynamic exposure). The velocity and direction of the substrate table WT relative to the support structure (e.g. mask table) MT may be determined by the (de-)magnification and image reversal characteristics of the projection system PS.
3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

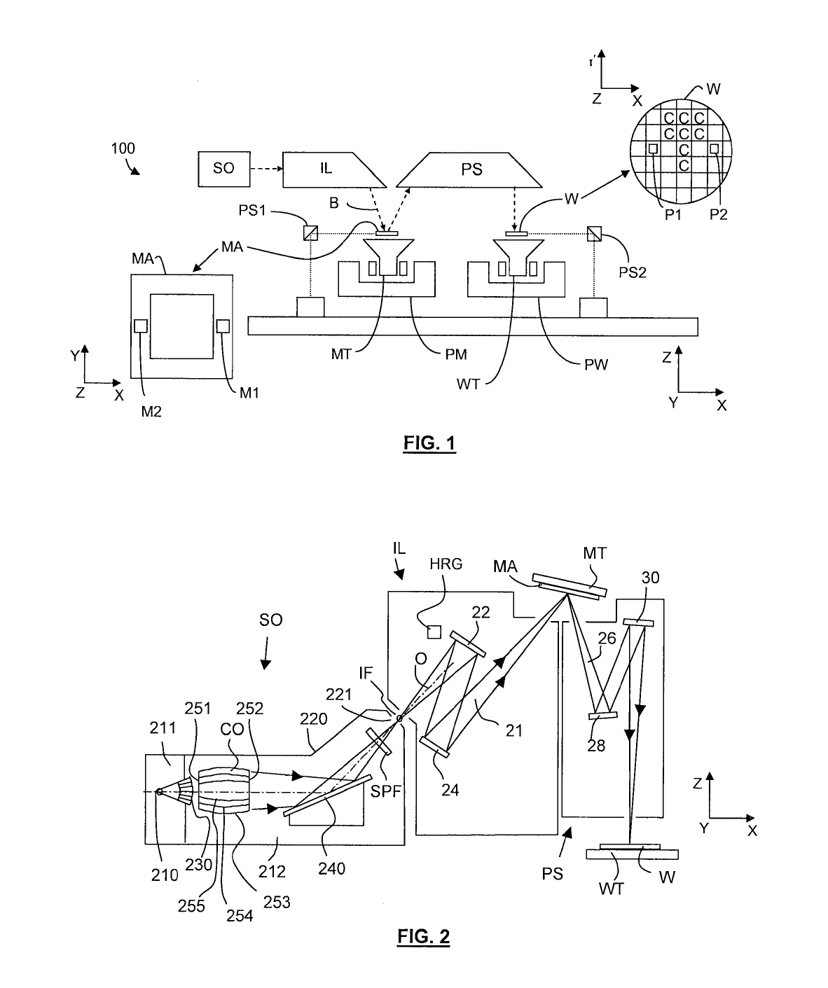

FIG. 2 shows the apparatus 100 in more detail, including the source collector module SO, the illumination system IL, and the projection system PS. The source collector module SO is constructed and arranged such that a vacuum environment can be maintained in an enclosing structure 220 of the source collector module SO. An EUV radiation emitting plasma 210 may be formed by a discharge produced plasma (DPP) source. EUV radiation may be produced by a gas or vapor, for example Xe gas, Li vapor or Sn vapor in which the (very hot) plasma 210 is created to emit radiation in the EUV range of the electromagnetic spectrum. The (very hot) plasma 210 is created by, for example, an electrical discharge creating an at least partially ionized plasma. Partial pressures of, for example, 10 Pa of Xe, Li, Sn vapor or any other suitable gas or vapor may be required for efficient generation of the radiation. In an embodiment, a plasma of excited tin (Sn) is provided to produce EUV radiation.

The radiation emitted by the plasma 210 is passed from a source chamber 211 into a collector chamber 212 via an optional gas barrier or contaminant trap 230 (in some cases also referred to as contaminant barrier or foil trap) which is positioned in or behind an opening in source chamber 211. The contaminant trap 230 may include a channel structure. Contamination trap 230 may also include a gas barrier or a combination of a gas barrier and a channel structure. The contaminant trap or contaminant barrier 230 further indicated herein at least includes a channel structure, as known in the art.

The collector chamber 212 may include a radiation collector CO which may be a so-called grazing incidence collector. Radiation collector CO has an upstream radiation collector side 251 and a downstream radiation collector side 252. Radiation that traverses collector CO can be reflected off a grating spectral filter 240 to be focused in a virtual source point IF. The virtual source point IF is commonly referred to as the intermediate focus, and the source collector module SO is arranged such that the intermediate focus IF is located at or near an opening 221 in the enclosing structure 220. The virtual source point IF is an image of the radiation emitting plasma 210. Before passing through the opening 221, the radiation may pass through an optional spectral purity filter SPF. In other embodiments, the spectral purity filter SPF may be located in a different part of the lithographic apparatus (e.g. outside of the source collector module SO).

Subsequently the radiation traverses the illumination system IL, which may include a facetted field mirror device 22 and a facetted pupil mirror device 24 arranged to provide a desired angular distribution of the radiation beam 21, at the patterning device MA, as well as a desired uniformity of radiation intensity at the patterning device MA. Upon reflection of the beam of radiation 21 at the patterning device MA, held by the support structure MT, a patterned beam 26 is formed and the patterned beam 26 is imaged by the projection system PS via reflective elements 28, 30 onto a substrate W held by the wafer stage or substrate table WT.

The lithographic apparatus is also provided with at least one hydrogen radical generator HRG for generating hydrogen radicals that may be used to cleanse one or surfaces of, for example, optical elements of the lithographic apparatus. The optical elements may be one or more of the mirrors or reflective surfaces or devices described above, or any other element that may be used to manipulate (e.g. reflect, refract, or the like) a radiation beam in the lithographic apparatus, or a sensor. Embodiments of the hydrogen radical generator HRG will be discussed in more detail below. In some embodiments, only a single hydrogen radical generator HRG may be provided and hydrogen radicals generated using that hydrogen radical generator may be directed towards one or more optical elements, for example, by appropriate gas flow, diffusion or the like. In another embodiment, more than one hydrogen radical generator HRG may be provided, for example one or more hydrogen radical generator HRG for each optical element, or for each separate compartment within the lithographic apparatus.

More elements than shown may generally be present in illumination optics unit IL and projection system PS. The grating spectral filter 240 may optionally be present, depending upon the type of lithographic apparatus. Further, there may be more reflective elements (e.g. mirrors or the like) present than those shown in the Figures, for example there may be 1-6 additional reflective elements present in the projection system PS than shown in FIG. 2.

Collector CO, as illustrated in FIG. 2, is depicted as a nested collector with grazing incidence reflectors 253, 254 and 255, just as an example of a collector (or collector mirror). The grazing incidence reflectors 253, 254 and 255 are disposed axially symmetric around an optical axis O and a collector CO of this type is preferably used in combination with a discharge produced plasma source, often called a DPP source.

Alternatively, the source collector module SO may be part of, comprise or form an LPP radiation system as shown in FIG. 3. Referring to FIG. 3, a laser LA is arranged to deposit laser energy into a fuel, such as a droplet or region or vapor of xenon (Xe), tin (Sn) or lithium (Li), creating the highly ionized plasma 210 with electron temperatures of several 10's of eV. The energetic radiation generated during de-excitation and recombination of these ions is emitted from the plasma 210, collected by a near normal incidence collector CO and focused onto the opening 221 in the enclosing structure 220. Before passing through the opening 221, the radiation may pass through an optional spectral purity filter SPF. In other embodiments, the spectral purity filter SPF may be located in a different part of the lithographic apparatus (e.g. outside of the source collector module SO).

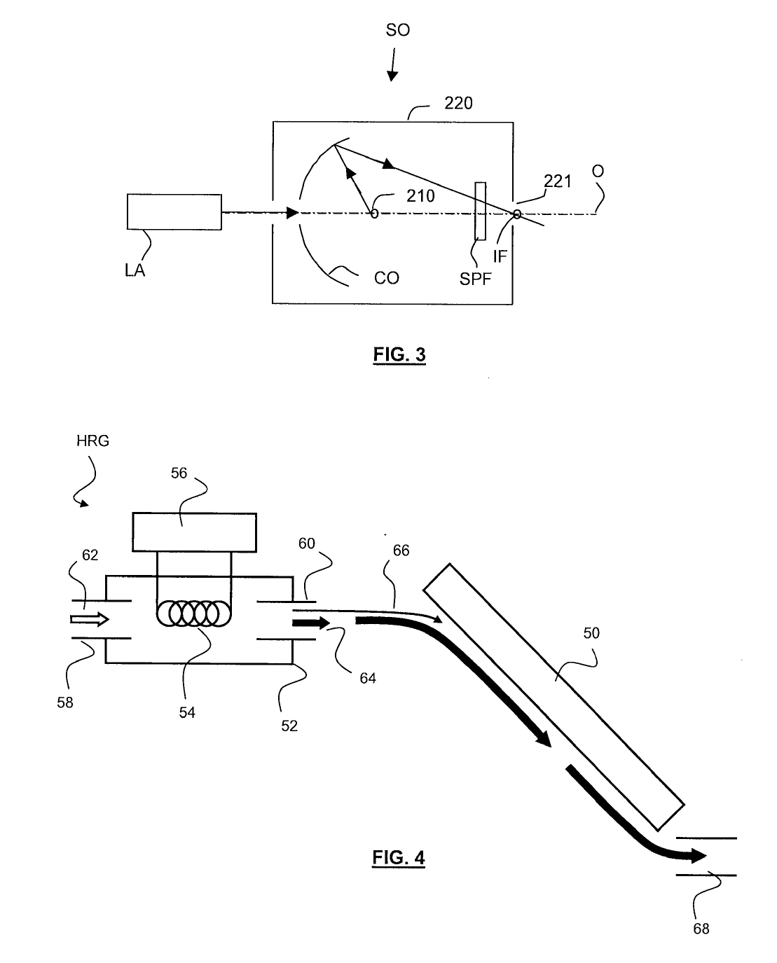

As described above, a hydrogen radical generator may be used to remove contamination from one or more optical elements of a lithographic apparatus. FIG. 4 schematically depicts a hydrogen radical generator HRG relative to an optical element 50 of a lithographic apparatus (not to any particular scale). In this Figure, and indeed in any embodiment of the invention described herein, the hydrogen radical generator HRG may be proximate or adjacent to the optical element that is to be cleansed, or may be remote from the optical element with hydrogen radicals being delivered from the hydrogen radical generator to the optical element that needs to be cleansed (e.g. by appropriate flow, diffusion and/or via a conduit or the like). In any embodiment, the hydrogen radical generator will thus be in fluid connection with the lithographic apparatus, in order to allow hydrogen radicals to be delivered from the hydrogen radical generator to the lithographic apparatus, and/or the optical elements contained therein.

The hydrogen radical generator HRG may comprise a compartment 52. Located in that compartment 52 is a metal filament 54. The metal filament 54 may, for example be tungsten, or indeed any other metal which can withstand the temperature required to atomize molecular hydrogen. The filament is shown as having a coil-like shape in the Figure, but in other embodiments the filament may take a different form.

The metal filament 54 is in connection with, controlled by and driven by a controller 56. The controller 56 is able to control the temperature of the metal filament 54 by appropriate control of a driving current provided to and passing through the metal filament 54. The controller 56 is shown as being located outside of the compartment 52, but in other embodiments can be located within the compartment 52, or form part of the compartment 52.

The compartment 52 is provided with an inlet 58 and an outlet 60 for allowing the passage of gas or the like (e.g. particles, atoms, molecules) into and out of the compartment 52 respectively. Although not shown in the Figure, the hydrogen radical generator HRG may be provided with or be used in conjunction with one or more pumps for drawing or blowing gas or the like into the hydrogen radical generator and/or ejecting gas out of and away from the hydrogen radical generator. In the Figure, the outlet 60 is shown as being directed towards the optical element 50. However, in other embodiments other arrangements may be possible or desired. For example, one or more tubes or conduits or the like may guide gas or the like from the hydrogen radical generator to one or more optical elements, or parts thereof.

Referring back to FIG. 4, in use molecular hydrogen 62 is passed into or drawn into the compartment 52 and passed over (e.g. through and/or around) the metal filament 54. This is undertaken when the temperature of the metal filament 54 is an atomization temperature (e.g. 1300° C.-2500° C.), sufficient to atomize the molecular hydrogen 62 and to generate hydrogen radicals 64 for use in cleansing the optical element 50. As discussed above, the metal filament 54, or at least a part thereof, may become oxidized (e.g. may comprise or be provided with a metal-oxide surface layer or region) due to exposure of the metal filament 54 to an oxidant (e.g. air, water, oxygen or the like). Such exposure may take place when the metal filament 54 or the hydrogen radical generator HRG as a whole (or even the lithographic apparatus as a whole) is manufactured, transported, opened up for maintenance, or the like. The presence of the metal-oxide, combined with the high temperatures (e.g. 1300° C.-2500° C.) may result in evaporation of some or all of the metal-oxide. Thus, not only will hydrogen radicals 64 be ejected from the hydrogen radical generator HRG, but also evaporated metal-oxide 66 will be ejected from the hydrogen radical generator HRG.

Although the hydrogen radicals 64 may be used to cleanse the optical element 50 (for example, by the radicals 64 reacting with and resulting in the removal of carbon from the surface of the optical element 50), the hydrogen radicals 64 might reduce the metal-oxide 66 into the pure metal but will not, in general, result in a gaseous form of the metal in contact with metal-oxide 66 that has been deposited on the optical element 50. Thus, the metal-oxide 66 will itself or in its metallic form be deposited upon and result in contamination of the optical element 50. Such contamination may result in degradation of the optical performance of the optical element 50, and thus degradation in the optical performance of the lithographic apparatus as a whole.

Further to the apparatus already described, an extraction point 68 is provided (in this example, adjacent to the optical element 50, although other locations may be used) to extract hydrogen, hydrogen radicals 64 and/or any contamination removed by the hydrogen radicals 54 from the vicinity of the optical element 50, and possibly out of and away from the lithographic apparatus. However, the extraction point 58, and any pulling force that might be provided, may not remove contamination of the optical element 50 caused by deposition of the evaporated metal-oxide 66.

Cleaning of the optical element 50 using hydrogen radicals 54 may in fact result in contamination of the optical element 50 by deposition of metal-oxide 66 generated by the hydrogen radical generator HRG. It may be desirable to be able to reduce the contamination of the optical element 50 as a result of deposition of a metal-oxide 66 on the optical element 50.

In accordance with the an embodiment, there are provided methods of or for reducing contamination generated by a hydrogen radical generator and subsequent deposition of the contamination on an optical element of a lithographic apparatus. The methods involve either the reduction of the metal-oxide on a metal filament of the hydrogen radical generator prior to or during the atomization of molecular hydrogen and generation of hydrogen radicals for use in cleaning of the optical elements, or to the use of a barrier located selectively locatable in-between the metal filament (or, in general, the hydrogen radical generator) and the optical element to be cleansed when any evaporation of metal-oxide is taking place.

According to an aspect of the invention, there is therefore provided a method of reducing a contamination generated by a hydrogen radical generator, and subsequent deposition of the contamination on an optical element of a lithographic apparatus. The method comprises providing a first part of a metal filament of the hydrogen radical generator that includes a metal-oxide with molecular hydrogen, when the temperature of the first part of the metal filament is a reduction temperature, which is less than an evaporation temperature of the metal-oxide.

In accordance with an aspect of the invention, there is provided a method of reducing contamination generated by a hydrogen radical generator, and subsequent deposition of the contamination on an optical element of a lithographic apparatus. The method comprises evaporating metal-oxide present on a metal filament of the hydrogen radical generator when a barrier (which includes a part of the barrier) is located in-between the hydrogen radical generator and the optical element. ‘In-between’ may be anywhere in the path that evaporated metal-oxide might take between the hydrogen radical generator (or the metal filament thereof) and the optical element. For example, ‘in-between’ may not be equated to in the line-of-sight between the metal filament and the optical element. For instance, the barrier may be located in or constitute a part of a conduit that has a path that is not aligned with or which coincides with a line-of-sight between the metal filament and the optical element.

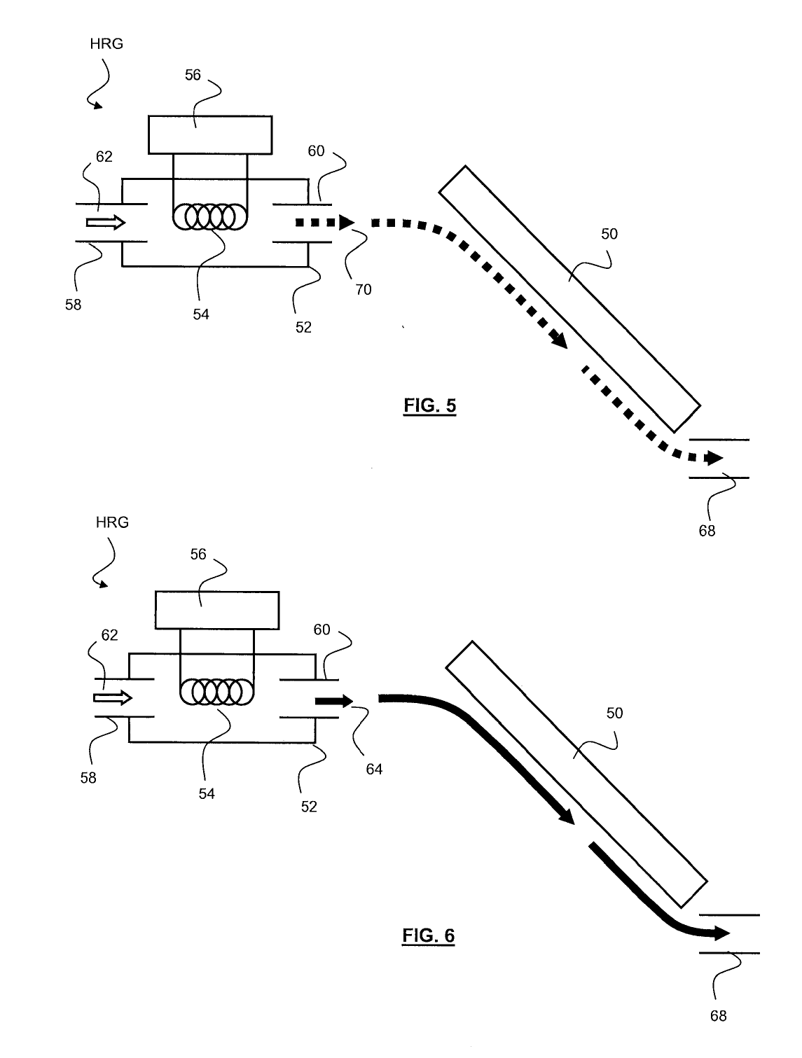

Embodiments of the aspects of the invention will now be described, by way of example only, with reference to FIGS. 5 to 8. Like features appearing in different Figures (for example, including earlier Figures such as FIG. 4) are given the same reference numerals for clarity and consistency. It should be noted that the Figures are not drawn to any particular scale, unless explicitly stated otherwise.

FIG. 5 schematically depicts, in general, substantially the same hydrogen radical generator HRG and optical element 50 as shown in and described with reference to FIG. 4. However, a difference between the hydrogen radical generator HRG shown in FIG. 4 and that shown in FIG. 5 relates to the controller 56. In FIG. 5, the controller 56 is either a different controller, or a differently configured controller. The controller 56 is different in that the controller 56 in FIG. 5 is arranged such that when molecular hydrogen 62 is passed over the metal filament 54, the temperature of the metal filament 54 (or at least a part thereof) may be controlled (at least at some time) to be a reduction temperature, which is less than or equal to an evaporation temperature of the metal-oxide present on or contained within the metal filament 54. For example, this reduction temperature may be in the range of about 400° C.-1200° C., in comparison with an atomization temperature used to atomize molecular hydrogen which may be in the range of about 1300° C. to 2500° C.

When the molecular hydrogen 62 is passed over the filament 54 when the filament 54 is at the reduction temperature, a chemical reaction takes place between the metal-oxide and the molecular hydrogen 62 to result in the formation of the metal in pure form (which remains on the filament 54) and H₂O. The H₂O 70 may be extracted by the extraction point 68. If the metal filament is formed from or comprises tungsten, the metal-oxide might be tungsten oxide, or a variety thereof, and the pure metal remaining after the chemical reaction will be tungsten.

The method described above may be continued or repeated until the metal-oxide has been completely removed, or at least satisfactorily removed (e.g. by or to a certain percentage by weight or area) from the metal filament 54 or the particular parts thereof.

In order to enhance speed of the reduction, the H₂ flow may be switched off.

Different parts of the metal filament 54 may reach different temperatures for a given driving current provided by the controller 56. Thus, the driving current of the metal filament 54 may be increased for a subsequent repetition of the method to ensure that usually cooler parts of the metal filament 54 also reach the, or a, reduction temperature sufficient to result in the above-mentioned chemical reaction to take place. Alternatively or additionally, the hydrogen flow or pressure may be reduced, thereby reducing heat transport of the molecular hydrogen 62, resulting in a higher temperature build-up.

The above-mentioned chemical reaction may take place at a wide range of temperatures. However, if the temperature is too low, the chemical reaction may take too long, resulting in an increased down-time for the hydrogen radical generator HRG before it can be used for cleansing, and perhaps thus the lithographic apparatus as a whole. If a temperature is too high, however, the metal-oxide may be evaporated, which is undesirable since this may lead to contamination of the optical element 50.

In this embodiment, and indeed in any other embodiment, the presence of metal-oxide on the metal filament 54 may be detected optically, or by monitoring changes in driving-current or resistance of the metal filament 54, or in any other appropriate manner.

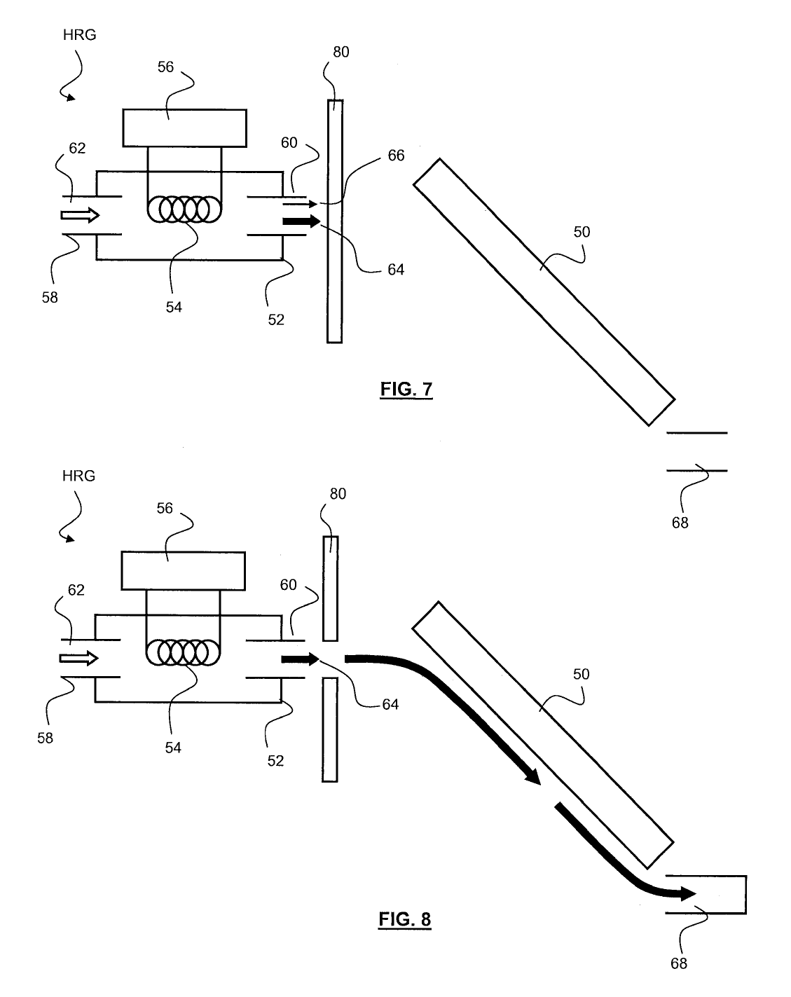

When the metal-oxide has been satisfactorily removed from the metal filament 54 the method may further comprise increasing the temperature of the metal filament (e.g. using the controller 54) to an atomization temperature, sufficient to atomize molecular hydrogen 62 passing over the metal filament 54 and to generate hydrogen radicals 64 for use in cleansing the optical element 50. This situation is shown in FIG. 6.

The method described above may be undertaken after the metal filament 54 has been exposed to the oxidant in question (e.g. air, oxygen, water or the like) and before the temperature of the metal filament 54 is increased to an atomization temperature, sufficient to atomize molecular hydrogen passing over the filament and to generate hydrogen radicals for use in cleansing the optical element 50. In this way, contamination of the optical element 50 by evaporated metal-oxide should be reduced or even eliminated. The method (and any method described herein) may be undertaken each and every time the metal filament 54 is exposed to the oxidant, for example a certain number of hours or the like. The reduction may be performed each time before the filament 54 reaches atomization temperature. Alternatively or additionally, the method may be undertaken each and every time a level of metal-oxide present on the filament 54 reaches a certain threshold value (which could be zero, or a non-zero value, and/or which level or value could be determined by appropriate optical or electrical detection). The metal filament 54 may be controlled such that its temperature is at its reduction temperature before molecular hydrogen is passed over the filament, or as molecular hydrogen is passed over the filament.

It is likely that the reduction temperature discussed above (or further below) will be less than the atomization temperature required to atomize the molecular hydrogen. Furthermore, it is likely that the metal or metals forming the metal filaments will be a metal or metals whose metal-oxides evaporate more readily than the metal in pure form. This may be true for all embodiments discussed herein.

For this embodiment, and indeed any embodiment described herein, the method may be undertaken when the hydrogen radical generator is in fluid connection with the lithographic apparatus. This means that the method may be undertaken when the hydrogen radical generator is located within the lithographic apparatus, or connected to the lithographic apparatus such that fluid (e.g. gas such as hydrogen radicals or the like) may be passed from the hydrogen radical generator to the lithographic apparatus, and/or optical elements thereof. This may alternatively or additionally be described as undertaking the method when the hydrogen radical generator is in-situ in terms of its normal position within or relative to the lithographic apparatus and/or an optical thereof. If, in use, the hydrogen radical generator is connected to the lithographic apparatus, the lithographic apparatus may be described as comprising the hydrogen radical generator.

FIG. 7 schematically depicts an embodiment of the invention. FIG. 7 schematically depicts the same hydrogen radical generator HRG and optical element 50 as shown in and described with reference to preceding Figures. However, in this embodiment there is additionally provided a barrier 80. The barrier 80 (which includes a part of the barrier) is arranged to be moveable in-between the hydrogen radical generator HRG and the optical element 50 when evaporation of metal-oxides 66 present on the metal filament 54 is taking place. The barrier 80 may thus block evaporated metal-oxide 66 from reaching the optical element 50. The evaporated metal-oxide may accumulate on the barrier 80

‘In-between’ may be anywhere in the path that evaporated metal-oxide 66 might take between the hydrogen radical generator HRG (or the metal filament 54 thereof) and the optical element 50. For example, ‘in-between’ may not be equated to in the line-of-sight between the metal filament 54 and the optical element 50. For instance, the barrier 80 may be located in or constitute a part of a conduit (not shown) that has a path that is not aligned with or which coincides with a line-of-sight between the metal filament 54 and the optical element 50.

FIG. 7 shows that molecular hydrogen 62 may pass over the filament 54 when the filament (or a part thereof) is at a temperature sufficient to evaporate the metal-oxide located thereon. At this evaporation temperature, hydrogen radicals 64 may also be generated. The hydrogen radicals 64 and evaporated metal-oxide 66 leaves the hydrogen radical generator HRG. The barrier 80 prevents the evaporated metal-oxide 66 at least from reaching the optical element 50.

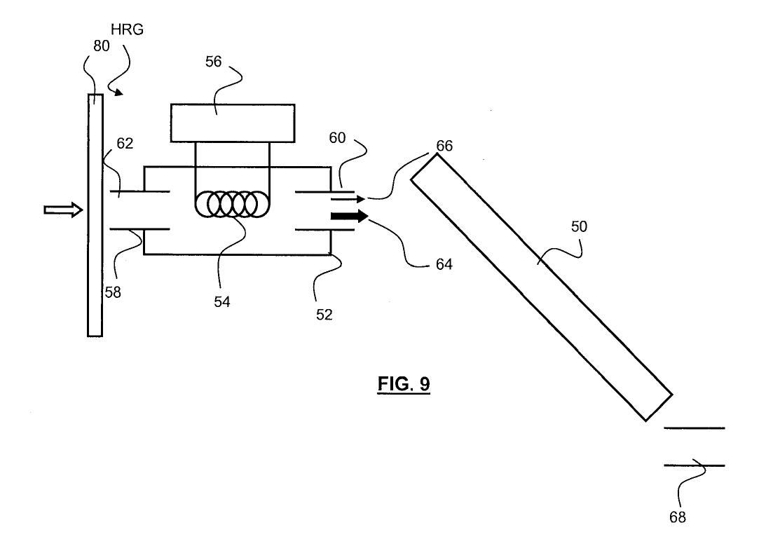

FIG. 8 shows that once the metal-oxide has been removed, or has stopped evaporating, the barrier 80 may be moved from a first configuration to a second configuration. In the first configuration, evaporated metal-oxide and/or hydrogen radicals is or are prevented from passing from the hydrogen radical generator to the optical element. In the second configuration, shown in FIG. 8, hydrogen radicals 64 generated by the hydrogen radical generator HRG are allowed to pass to the optical element 50 to cleanse the optical element 50.

The barrier 80 is shown as being somewhat arbitrarily located in-between the hydrogen radical generator HRG and the optical element 50. In more specific embodiments, the barrier 80 may form part of a compartment surrounding the metal filament 54, or the hydrogen radical generator HRG. Alternatively or additionally, the barrier, or another barrier, may form part of a compartment surrounding the optical element, or one or more optical elements.

As discussed above, in an embodiment, the metal filament may be heated to a reduction temperature to ensure that a chemical reaction results in which metal-oxide is transformed into the metal in pure form and H₂O (i.e. there is a reduction of the metal-oxide). In another embodiment, the temperature of the filament may be increased until the metal-oxide begins to evaporate, which may coincide with the temperature at which atomization of the molecular hydrogen begins to takes place. Increasing of the temperature of the filament may be undertaken in any appropriate manner, for example at a certain rate or gradient, or in a step-wise manner, by a corresponding increase (or change in increase) of the driving current provided to the filament.

FIG. 9 schematically depicts a hydrogen radical generator in relation to an optical element of a lithographic apparatus, together with a barrier 80, in accordance with an embodiment of the invention. In the embodiment of FIG. 9, the barrier 80 is located upstream in the path of the flow of molecular hydrogen towards the hydrogen radical generator HRG and prevents the molecular hydrogen from reaching the metal filament 54.

In use, the temperature of the filament 54 may be increased until the metal-oxide, for instance tungsten oxide, begins to evaporate. Again, this may coincide with the temperature at which atomization of the molecular hydrogen begins to takes place. The filament may be heated to a temperature in the range of about 1300° C. to about 2500° C., for example about 1860° C. The pressure in the hydrogen radical generator HRG may be about 5·10⁻⁷ mbar. Because the barrier 80 ensures that the molecular hydrogen does not reach the filament 54, the flow of hydrogen does not transport the metal-oxide to the optical element. The metal-oxide may be a tungsten filament with tungsten oxide deposited on it. The tungsten oxide may be W₂O₃, WO₂, WO₃, or any other form of tungsten oxide.

Instead of using the barrier 80 of the embodiment of FIG. 9, the flow of molecular hydrogen may simply be switched off.

In some embodiments, the hydrogen radical generator in conjunction with its controller may be made, sold, and used in isolation. However, it is likely that the hydrogen radical generator may find particular use in relation to its use with a lithographic apparatus as described above. For instance, the hydrogen radical generator may find use with a lithographic apparatus comprising an illumination system configured to condition a radiation beam. The apparatus may alternatively or additionally comprise a support constructed to support a patterning device, the patterning device being capable of imparting a radiation beam with a pattern in its cross-section to form a patterned radiation beam. A substrate table constricted to all the substrates may alternatively or additionally be provided. The apparatus may alternatively or additionally be provided with a projection system configured to project the pattern radiation beam onto a target portion of the substrate.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. The descriptions above are intended to be illustrative, not limiting. Thus it will be apparent to one skilled in the art that modifications may be made to the invention as described without departing from the scope of the claims set out below.

What is claimed is:

1. A method of reducing contamination generated by a hydrogen radical generator and deposited on an optical element of a lithographic apparatus, the method comprising:
providing molecular hydrogen to a first part of a metal filament of the hydrogen radical generator, the first part including a metal oxide, when the first part is at a reduction temperature that is equal to or less than an evaporation temperature of the metal-oxide.

2. The method of claim 1, wherein the method is repeated to reduce an amount of oxide on a second, different part of the metal filament.

3. The method of claim 2, wherein a driving current of the metal filament is increased to repeat the method.

4. The method of claim 2, wherein a pressure of the molecular hydrogen is reduced to repeat the method.

5. The method of claim 1, further comprising increasing the temperature of the metal filament to an atomization temperature, sufficient to atomize molecular hydrogen passing over the metal filament and to generate hydrogen radicals for use in cleansing the optical element.

6. The method of claim 1, wherein the method is undertaken after the metal filament has been exposed to an oxidant, and before the temperature of the metal filament is increased to an atomization temperature, sufficient to atomize molecular hydrogen passing over the metal filament and to generate hydrogen radicals.

7. The method of claim 1, wherein the method is undertaken after the metal filament has been exposed to an oxidant.

8. A hydrogen radical generator for use in cleansing an optical element of lithographic apparatus, the hydrogen radical generator comprising:
a metal filament; and
a controller configured to control a temperature of a first part of the metal filament of the hydrogen radical generator, the first part including a metal-oxide,
the controller being arranged to provide molecular hydrogen to the first part of the metal filament when the temperature of the first part of the metal filament is at a reduction temperature less than or equal to an evaporation temperature of the metal-oxide.

9. A method of reducing contamination generated by a hydrogen radical generator and deposited on an optical element of a lithographic apparatus, the method comprising:
evaporating part of metal-oxide present on a metal filament of the hydrogen radical generator.

10. The method of claim 9, wherein the method is undertaken after the metal filament has been exposed to an oxidant, and before cleansing of the optical element is undertaken using hydrogen radicals generated by the hydrogen radical generator.

11. The method of claim 9, wherein before, during, or after said evaporating, molecular hydrogen is passed over the metal filament when the temperature of the metal filament is an atomization temperature, sufficient to atomize molecular hydrogen passing over the metal filament and to generate hydrogen radicals.

12. The method of claim 9, wherein the barrier is moveable from a first configuration, in which evaporated metal-oxide and/or hydrogen radicals is/are prevented from passing from the hydrogen radical generator to the optical element, to a second configuration, in which hydrogen radicals generated by the hydrogen radical generator are allowed to pass to the optical element.

13. The method of claim 9, wherein the part of metal-oxide present on a metal filament of the hydrogen radical generator is evaporated when a barrier is provided constructed and arranged to prevent a hydrogen flow to be established to the filament and the optical element; or
wherein the part of metal-oxide present on a metal filament of the hydrogen radical generator is evaporated when a barrier is located between the hydrogen radical generator and the optical element; and
wherein the barrier forms part of a compartment surrounding the metal filament, or the hydrogen radical generator.

14. The method of claim 9, wherein the part of metal-oxide present on a metal filament of the hydrogen radical generator is evaporated when a barrier is provided constructed and arranged to prevent a hydrogen flow to be established to the filament and the optical element; or
wherein the part of metal-oxide present on a metal filament of the hydrogen radical generator is evaporated when a barrier is located between the hydrogen radical generator and the optical element; and
wherein the barrier forms part of a compartment surrounding the optical element.

15. A lithographic apparatus comprising:
an optical element;
a hydrogen radical generator configured to generate hydrogen radicals for use in cleansing the optical element; and
a barrier, arranged to be moveable between the hydrogen radical generator and the optical element when evaporation of metal-oxide on a metal filament of the hydrogen radical generator takes place.
